(19) United States
(12) Patent Application Publication
(10) Pub. No.: US 2015/0381895 A1
(43) Pub. Date: Dec. 31, 2015

(54) Method of Generating Selfie for a Portable Device

(71) Applicant: Lo Mei-Ling, New Taipei City (TW)

(72) Inventor: Lo Mei-Ling, New Taipei City (TW)

(21) Appl. No.: 14/258,023

(22) Filed: Apr. 22, 2014

(51) Int. Cl. H04N 5/232; H04N 5/225; G06T 7/00; H04N 5/265; G06T 5/00

(52) U.S. Cl. CPC H04N 5/23293; H04N 5/265; G06T 5/002; G06T 7/0081; H04N 5/2258

(57) ABSTRACT

The present invention provides a method for generating self-image with desired image for a portable device comprising: providing a control unit, a first and a second image capturing device coupled to the control unit and a display coupled to the control unit. A first picture is taken by the first image capturing device and a second picture is taken by the second image capturing device, followed by displaying the first picture on an upper layer and a second picture on a lower layer on the display. The first picture or the second picture is adjusted and the first picture and the second picture are combined to generate a composed image.

### TECHNICAL FIELD

The present invention generally relates to a portable device, especially to a method for a portable communication device to generate a selfie or self-portrait photograph.

### DESCRIPTION OF RELATED ART

In pace with the development of IT (information technology), information can be exchanged with higher speed and greater capacity. The third generation mobile protocol can make users enjoy diverse services, and immediately information exchange is executable such that live broadcast can be watched via the mobile communication internet or the Internet. All of the portable devices employed a so called front camera to capture the selfie or self-image. A selfie is a type of self-portrait photograph, typically taken with a hand-held digital camera or camera phone. Selfies are often casual, and are typically taken either with a camera held at arm's length or in a mirror. The front camera is typically set at the same side with the display, and a rear camera is set back of the display to take a picture. However, it is unlikely for a user to take a picture with the desired background when takes the selfie.

### SUMMARY

The present invention provides a method for generating selfie with desired image for a portable device comprising: providing a control unit, a first and a second image capturing device are coupled to the control unit and a display is coupled to the control unit. A first picture is taken by the first image capturing device and a second picture is taken by the second image capturing device, followed by displaying the first picture on an upper layer and a second picture on a lower layer on the display. The first picture or the second picture is adjusted and the first picture and the second picture are combined to generate a composed image.

The first and the second image capture device include CMOS or CCD. The method further includes a step of removing a background of the first picture before displaying the first picture or/and a step of removing a background of the second picture before displaying the second picture.

The method further includes a step of dividing a display into two portions, followed by displaying a first and a second images capturing by the first and the second image capturing device on the divided display before taking pictures. The method includes a step of adjusting the first or second picture by size enlarging, squeezing, image rotating, translating, moving, swapping left and right, trimming, smoothing, noise reduction.

The image capture module comprises CMOS or CCD. A short range wireless internet module can be further included, which comprises Wi-Fi module, or 802.11 module, wherein a WiMAX (Worldwide Interoperability for Microwave Access) module can also be introduced.

The portable device comprising a multi-tasking module coupled to the control unit, a display segmentation unit coupled to the control unit to divide the display into at least two areas to display a receiving image captured by the self-image generating module.

### BRIEF DESCRIPTION OF THE DRAWINGS

FIG. 1 shows the diagram of the present invention.

FIG. 2 shows the embodiment of the present invention.

FIG. 3 shows the embodiment of the present invention.

FIG. 4 shows the embodiment of the present invention.

FIG. 5 shows the embodiment of the present invention.

### DETAILED DESCRIPTION

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. The present invention can be integrated in the device such as a mobile phone, a digital video camera, a digital camera, a PDA, a smart phone, a GPS, a digital photo frame, or a notebook, etc.

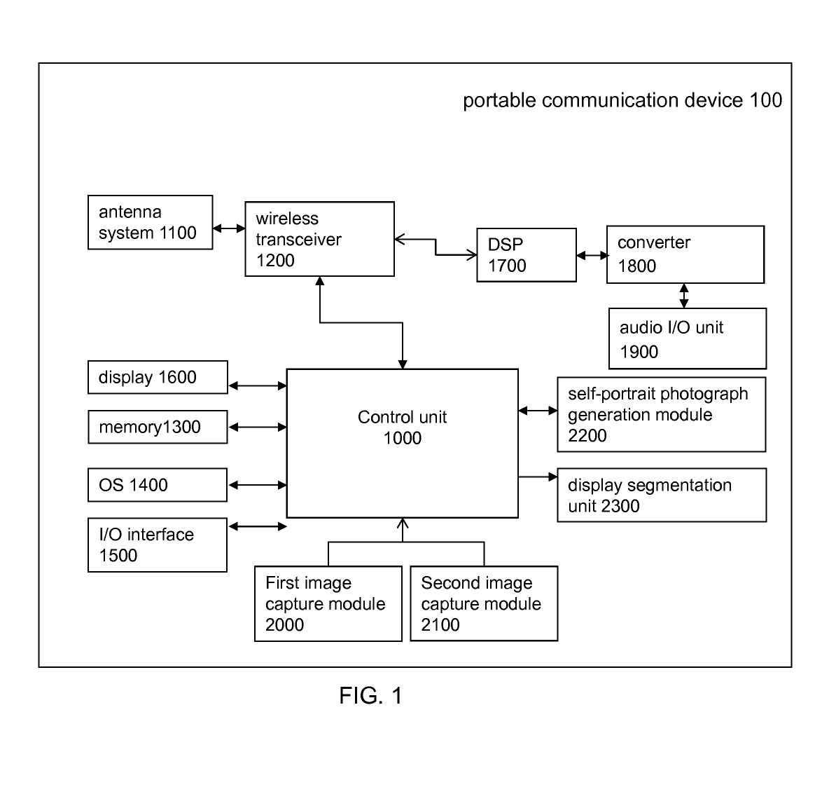

FIG. 1 exhibits a diagram of the portable communication device 100. The portable communication device 100 includes a wireless transceiver 1200, which can be a RF module for transmitting or receiving mobile signals. As well known, the RF module is coupled to an antenna system 1100 which may be single or multiple antennas according to demands, and RF module may further include the base band processor. The antenna system 1100 is connected to a radio transceiver 1200 for transmitting or receiving signals. The wireless radio transceiver 1200 is compatible with various mobile communication protocols, such as W-CDMA, CDMA2000, CDMA2001, TD-CDMA, TD-SCDMA, UWC0136, DECT, or 4G systems. These systems allow users to communicate through video telephone. The RF module may be introduced to perform transmitting and receiving of signals, frequency synchronization, base band processing, and digital signals processing, etc. The portable communication device 100 may include a DSP (digital signal processor) 1700 and/or a central control unit 1000, encoder/decoder (not shown) and A/V converter 1800, and the arrangement of those elements can be determined based on applications. The signals can be transmitted to the final actuators, that is, the audio I/O (input/output) unit 1900 via the DSP 1700 and the converter 1800.

The portable communication device 100 further comprises a display 1600 to display application user interface and information, OS (operation system) 1400, and memory 1300, wherein the memory 1300 includes nonvolatile FLASH memory. Aforementioned units can be coupled to the central control unit 1000 respectively or the DSP. The USB I/O interface 1500 is coupled to the central control unit 1000. The portable communication device 1000 may also include anther wireless transceiver such as WiFi or 802.11x (x refers to a, b, g, n), and the users can connect internet or hot spots via WiFi.

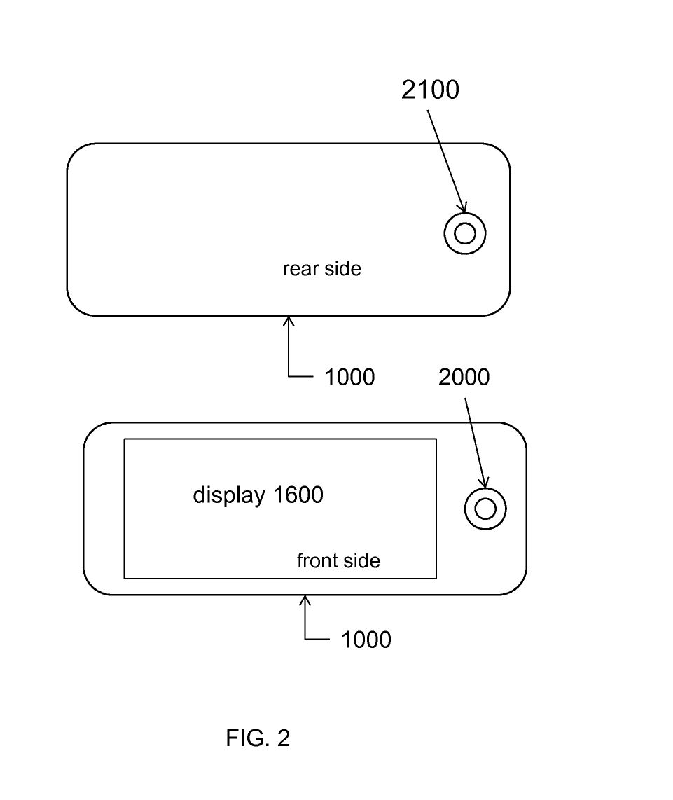

The first image capture module 2000 and the second image capture module 200 are respectively coupled with the control unit 1000. The first image capture module 2000 refers to a front camera and the second image capture module 2100 refers to a rear camera. Alternatively, the first image capture module 2000 refers to a rear camera and the second image capture module 2100 refers to a front camera. The front camera is set on the surface which includes a display, and the rear surface is opposite side to the front surface. The rear camera is set on the rear surface. A self-portrait photograph generation module 2200 is coupled to aforementioned control unit 1000. The first and second image capture module includes at least one image capture elements as shown in FIG. 2. The image capture elements can be CMOS, or CCD. After two captured images are captured and stored, the images can be processed by the self-portrait photograph generation module 2200 to generate merged image, alternatively, the image can be used as photo sticker, wallpaper, desktop, stereo images used for the address book, etc.

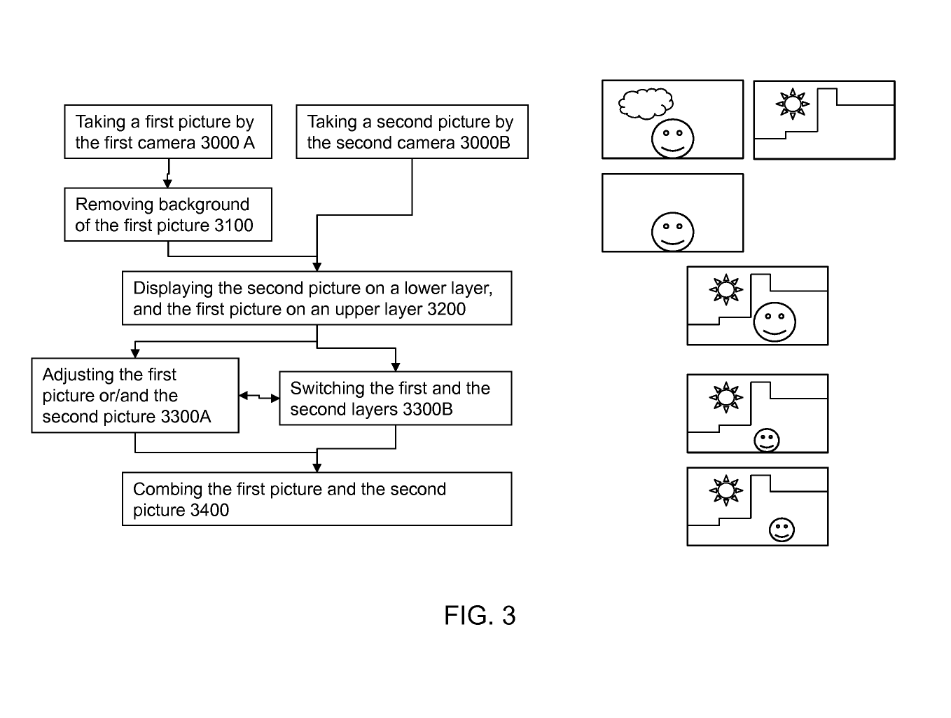

Please refer to FIG. 3, after the self-portrait photograph generating module is initiated, the first camera and the second camera are employed to take a front image and a rear image by the first camera and the second camera, respectively, when the user take a picture. For example, the self-portrait photograph can be taken by the font camera and the scene in front of the user may be taken by the rear image. In one preferred embodiment, the first and the second camera are simultaneously activated to take pictures in step 3000A and 3000B. In one example, the first picture is taken by the front camera and the second picture is taken by the rear camera. The background of the first picture is removed or filter by the self-portrait photograph generating module 2200 in step 3100, remaining the desired portion such as the user oneself image.

The next step 3200 is to display the second picture on a lower layer and the first picture on an upper layer on the display by the self-portrait photograph generating module 2200. At the stage, the two pictures are located on different layer, and they can be adjusted without interrupting another picture on the different layer as shown in step 3300A. The adjusting process may include size enlarging, squeezing, image rotating, translating, swapping left and right, trimming, fading, blurring, smoothing, noise reduction, and so on. The layers may be switched by the self-portrait photograph generating module 2200 in step 3300B. The original lower layer becomes upper layer, and the original upper layer becomes lower layer. The layers concept is similar with the Photoshop layer which is employed to merge different images with layer masks. In series on layers, it allows the user align and distribute layers in a document using the Move Tool and some handy options in the Options Bar.

The image data captured by the first and the second image capture device 2000, 2100 can be merged, thereby generating self-portrait photograph with desired background, followed by displaying on the display. For example, the user can obtain the self-image with the background he chosen and takes his self-image and the desired background by the first and the second camera 2000, 2100. By aforementioned features, aspects, teaching, and photograph imaging theory, users are able to see the self-image and the scene in front of the user on the display when making a photo. Aforementioned self-portrait photograph generation module can be software, firmware, or computer readable commands for displaying images in the digital camera.

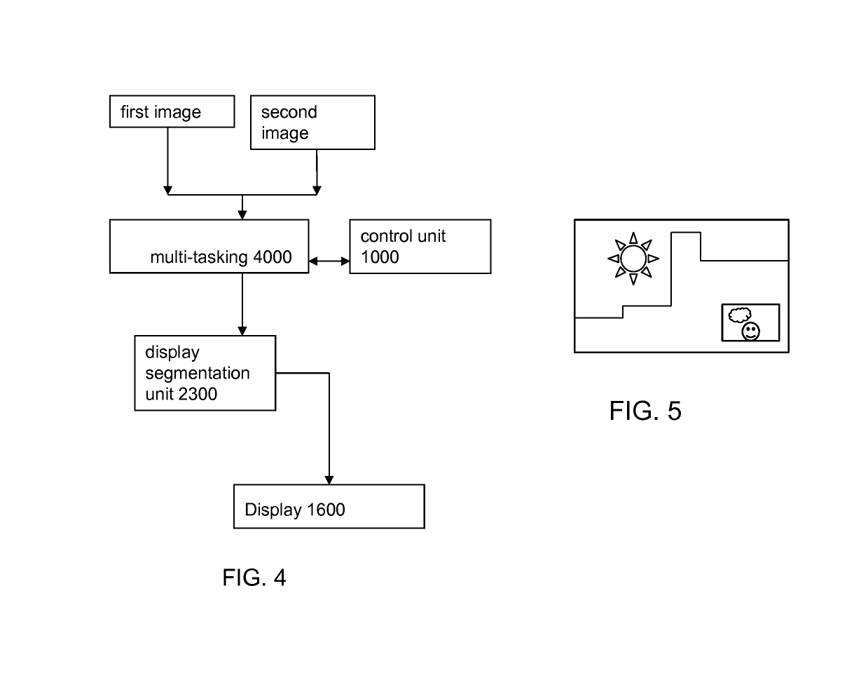

The portable communication device 1000 comprises an display segmentation unit 2300 coupled to the control unit 1000 for simultaneously dividing the display areas on the display for display multiple images including the first image and the second image when capturing the pictures by the first and the second cameras. The capture images before taken will be assigned to the divided display areas which may be separated, overlapped, or partially overlapped. Referred to FIG. 4, a plurality of input images are transferred to multi-tasking module 4000 for processing received images form a plurality of cameras. Before the image data signals transmitted to the display, aforementioned images are previously processed by the image segmentation unit 2300. The multitasking module 4000 refers to a method where multiple tasks (also known as processes) share common processing resources such as a CPU. Multitasking solves the one process one task problem by scheduling which task may be the one running at any given time, and when another waiting task gets a turn. The multi-tasking allow reassign the control unit from one task to another different task to achieve parallelism or context switches. Thus, the different task multi-tasking module may reassign the control unit to switch from one process to another different process to facility context switches.

Another alternative method is similar with the above aforementioned method, most of the step and procedures are the same, some of them are omitted. The selfie or the self-portrait photograph is combined with the picture to generate a picture in picture type image, as shown in FIG. 5. It may indicate who takes the picture. The first picture may refer to a copy-right indication. The second picture is generated with the copy-right indication after merging the first picture and the second picture. As the same with the above embodiment, the self-portrait photograph taken by the front camera is floating and movable on the second picture before merging. The user may moving the floating self-portrait photograph to desired location over the second picture.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A method for generating self-portrait photograph with desired image for a portable device comprising:
providing a control unit, a first and a second image capturing device coupled to said control unit and a display coupled to said control unit;
taking a first picture by said first image capturing device and a second picture by said second image capturing device;
displaying said first picture and a second picture on said display, wherein said first picture is overlapped with said second picture;
adjusting said first picture or said second picture; and
combining said first picture or said second picture to generate a merged image.

2. The method according to claim 1, wherein said first and said second image capture device is selected from a front camera and a rear camera of said portable device.

3. The method according to claim 1, further comprising a step of removing a background of said first picture before displaying said first picture.

4. The method according to claim 1, further comprising a step of removing a background of said second picture before displaying said second picture.

5. The method according to claim 1, further comprising dividing a display into two portions.

6. The method according to claim 5, further comprising a step of displaying a first and a second images capturing by said first and said second image capturing device on said divided display before taking pictures.

7. The method according to claim 1, further comprising a step of adjusting said first picture by size enlarging, squeezing, image rotating, translating, swapping left and right, trimming, fading, blurring, smoothing, noise reduction.

8. The method according to claim 1, further comprising a step of adjusting said second picture by size enlarging, squeezing, image rotating, translating, swapping left and right, trimming, smoothing, noise reduction.

9. The method according to claim 1, further comprising a multi-tasking module coupled to said control unit.

10. The method according to claim 1, further comprising a display segmentation unit coupled to said control unit to divide said display into at least two area to display images.

11. A method for generating self-portrait photograph with desired image for a portable device comprising:
providing a control unit, a first and a second image capturing device coupled to said control unit and a display coupled to said control unit;
displaying a first and a second images capturing by said first and said second image capturing device on said display before taking pictures;
taking a first picture by said first image capturing device and a second picture by said second image capturing device;
removing a background of said first picture before displaying said first picture;
displaying said first picture overlapping said second picture on said display;
adjusting said first picture or said second picture; and
combining said first picture or said second picture to generate a merged image.

12. The method according to claim 11, further comprising dividing a display into two portions.

13. The method according to claim 11, further comprising a step of adjusting said first or second picture by size enlarging, squeezing, image rotating, translating, swapping left and right, trimming, smoothing, noise reduction.

14. The method according to claim 11, wherein said first and said second image capture device is selected from a front camera and a rear camera of said portable device.

15. The method according to claim 11, further comprising a multi-tasking module coupled to said control unit.

16. The method according to claim 11, further comprising a display segmentation unit coupled to said control unit to divide said display into at least two area to display images.

17. A method for generating self-portrait photograph with desired image for a portable device comprising:
providing a control unit, a first and a second image capturing device coupled to said control unit and a display coupled to said control unit;
displaying a first and a second images capturing by said first and said second image capturing device on said display before taking pictures;
taking a first picture by said first image capturing device and a second picture by said second image capturing device;
removing a background of said first picture before displaying said first picture;
displaying said first picture overlapping said second picture on said display;
blurring said second picture or said second picture; and
combining said first picture and said second picture to generate a merged image.

18. The method according to claim 17, further comprising dividing a display into two portions.

19. The method according to claim 17, further comprising a step of adjusting said first or second picture by size enlarging, squeezing, image rotating, translating, swapping left and right, trimming, smoothing, noise reduction.

20. The method according to claim 17, wherein said first and said second image capture device is selected from a front camera and a rear camera of said portable device.
